(19) United States
(12) Patent Application Publication
(10) Pub. No.: US 2006/0170249 A1
(43) Pub. Date: Aug. 3, 2006

(54) Method and apparatus for manufacturing a trailer wall and wall formed thereby

(76) Inventors: Michael A. Conny, Beloit, OH (US); James A. Maiorana, Hartville, OH (US); James S. Arnold, Uniontown, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/105,773

(22) Filed: Apr. 14, 2005

Related U.S. Application Data
(60) Provisional application No. 60/648,853, filed on Feb. 1, 2005.

(51) Int. Cl. B62D 25/02

(52) U.S. Cl. 296/186.1

(57) ABSTRACT

A method for manufacturing a trailer wall includes welding wall members together on a work surface while pressing the wall members with a rotatable roller toward the work surface and cooling the wall members adjacent points of welding there between to reduce bowing of the wall members related to heat created in the wall members by the welding. A related apparatus includes a movable welding unit having a welding tip for welding a pair of wall members together at a plurality of locations while on a work surface. A rotatable roller is pivotally mounted on the welding unit for applying pressure to the wall members toward the work surface adjacent the welding tip while rolling along the wall members. A cooling unit moves liquid or gas coolant to provide the cooling effect. Preferably, the wall members are hollow shiplap panels and the coolant passes through the hollow panels.

### CROSS REFERENCE TO RELATED APPLICATIONS

This application claims priority from U.S. Provisional Application Ser. No. 60/648,853 filed Feb. 1, 2005; the disclosure of which is incorporated herein by reference.

### BACKGROUND OF THE INVENTION

1. Technical Field

The invention relates to trailer walls, such as those used with tractor trailers, and a method of and apparatus for manufacturing the same. More particularly, the invention relates to the use of hollow wall members and a method of welding the wall members together. Specifically, the invention relates to such hollow wall members having a ship-lap configuration and such a method and apparatus which prevent bowing of the wall during welding.

2. Background Information

The construction of trailer walls and the structural elements used therein come in a variety of forms. For example, some trailer walls are formed with a plurality of vertical support members with a metal skin attached on the outside thereof. This option provides a smooth exterior of the truck for reduction of wind resistance during travel and the vertical members additionally provide structures to which tie down members such as ropes and chains may be attached to secure loads inside the trailer. One disadvantage of this configuration is that objects such as the cargo may create dents from inside the trailer which show on the outside, thus reducing aesthetic appeal and increasing wind resistance. In addition, there is a tendency for the skin to wear out over time.

An alternate option is the use of vertical planks which may create in essence an interior skin and an exterior skin, or solid planks to create a solid wall. In comparison to horizontal planks, these vertical planks generally require more pieces to create a given wall, thereby lengthening the assembly period for such a wall. In addition, the multiple joints between the plurality of vertical planks creates potential weak areas which can be more flexible than a single piece of skin or horizontally elongated planks. Further, vertical joints are less preferable for use with trailer walls used on a dump truck, as the vertical joints create wear areas as the material in the truck abrades the wall at the joints when dumped rearwardly in a direction generally perpendicular to the vertical joints.

In addition, the manufacture of certain trailer walls present several problems. First, in particular where the wall members are elongated, there is a need to hold the wall members in a proper final position with respect to one another while they are being joined to one another. While it is easy to hold the ends of such wall members to a work surface, any of the wall members may be sufficiently warped so that the portion of the wall member between its ends may also need to be held down. Where only a pair of wall members are to be joined together, the warped portion may be held down fairly easily with clamps as well. However, using additional clamps along the length of the wall member is labor intensive and thus not very cost-effective. In addition, where the wall members are hollow, clamping along the length of the wall member may increase the risk of damage to the skin of the hollow wall member. Where several wall members are positioned adjacent one another on a work surface, the combined width of the wall members makes clamping even more impractical for the interior wall members and may require clamps having extended jaws which would interfere with welding or other joining procedures.

Second, when the wall members are joined by welding, the heat created by welding leads to bowing of the wall formed thereby. This bowing can be quite substantial in certain circumstances and may even make the joined wall members unusable for their intended purpose.

The present invention is concerned with the problems noted above as well as with providing improved joints between the structural members of a trailer wall.

### BRIEF SUMMARY OF THE INVENTION

The present invention provides a method of manufacturing a trailer sidewall comprising the steps of welding a first substantially hollow wall member to a second substantially hollow wall member at a plurality of points of welding by creating relative movement between a welding tip and the wall members; and pressing the wall members in a continuous manner with a pressure applicator toward a work surface whereby the pressing occurs adjacent each respective point of welding during formation of each respective point of welding.

The present invention also provides a method of manufacturing a trailer sidewall comprising the steps of welding a first substantially hollow wall member to a second substantially hollow wall member; and cooling the wall members adjacent a plurality of points of welding simultaneously with the step of welding.

The present invention further provides a trailer sidewall comprising a plurality of substantially hollow wall members formed of metal; each wall member having first and second spaced walls and first and second opposed connecting sides each extending between and connected to the first and second walls; each connecting side including a projection formed in part by one of the first and second walls; and each adjacent pair of wall members being joined together with the projection of the first connecting side of one of the adjacent pair overlapping the projection of the second connecting side of the other of the adjacent pair.

### BRIEF DESCRIPTION OF THE SEVERAL VIEWS OF THE DRAWINGS

FIG. 1 is a perspective view of the panel which is the main structural member of the trailer wall of the present invention.

FIG. 2 is an end elevational view of the panel of FIG. 1.

FIG. 3 is an end elevational view of the cap member of the trailer wall.

FIG. 4 is an end elevational view of the base member of the trailer wall.

FIG. 5 is a fragmentary perspective view of two panels welded together.

FIG. 6 is a side elevational view of a truck incorporating the trailer wall of the present invention.

FIG. 7 is a rear elevational view of the truck with portions cut away to show the trailer wall from the rear end.

FIG. 8 is an enlarged sectional view of a portion of the trailer wall indicated in FIG. 7.

FIG. 9 is an enlarged sectional view of the encircled portion of FIG. 8.

FIG. 10 is an enlarged sectional view of a portion of the trailer wall indicated in FIG. 7 and includes the cap member.

FIG. 11 is an enlarged sectional view of the encircled portion of FIG. 10 showing the upper joint between the panel and cap member.

FIG. 12 is an enlarged sectional view of the encircled portion of FIG. 10 showing the lower joint between the panel and cap member.

FIG. 13 an enlarged sectional view of a portion of the trailer wall indicated in FIG. 7 and includes the base member.

FIG. 14 is an enlarged sectional view of an encircled portion indicated in FIG. 13 showing the lower joint between the panel and base member.

FIG. 15 is an enlarged sectional view of an encircled portion indicated in FIG. 13 showing the upper joint between the panel and base member.

FIG. 16 is an enlarged sectional view of an encircled portion indicated in FIG. 13 showing the joint between the base member and the trailer bed.

FIG. 17 is a side elevational view of a welding unit, a work bench and one of the clamps used with the method of the present invention.

FIG. 18 is a front elevational view of the structure shown in FIG. 17.

FIG. 19 is an enlarged fragmentary sectional view of the structure of FIG. 17 showing the clamp holding a panel to the work bench.

FIG. 20 is similar to FIG. 17 and shows movement of the welding unit from a first position shown in dot-dash lines to a second position.

FIG. 21 is an enlarged fragmentary sectional view taken on line 21-21 of FIG. 20.

FIG. 22 is an enlarged view of the encircled portion of FIG. 21 and shows the welding wire prior to formation of a weld.

FIG. 23 is similar to FIG. 22 and shows the weld formed by the welding unit.

Similar numbers refer to similar parts throughout the specification.

### DETAILED DESCRIPTION OF THE INVENTION

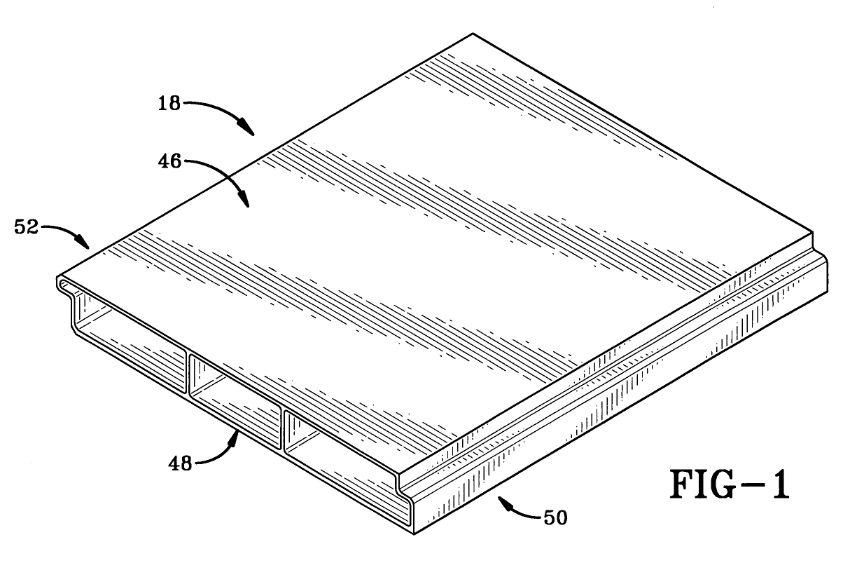

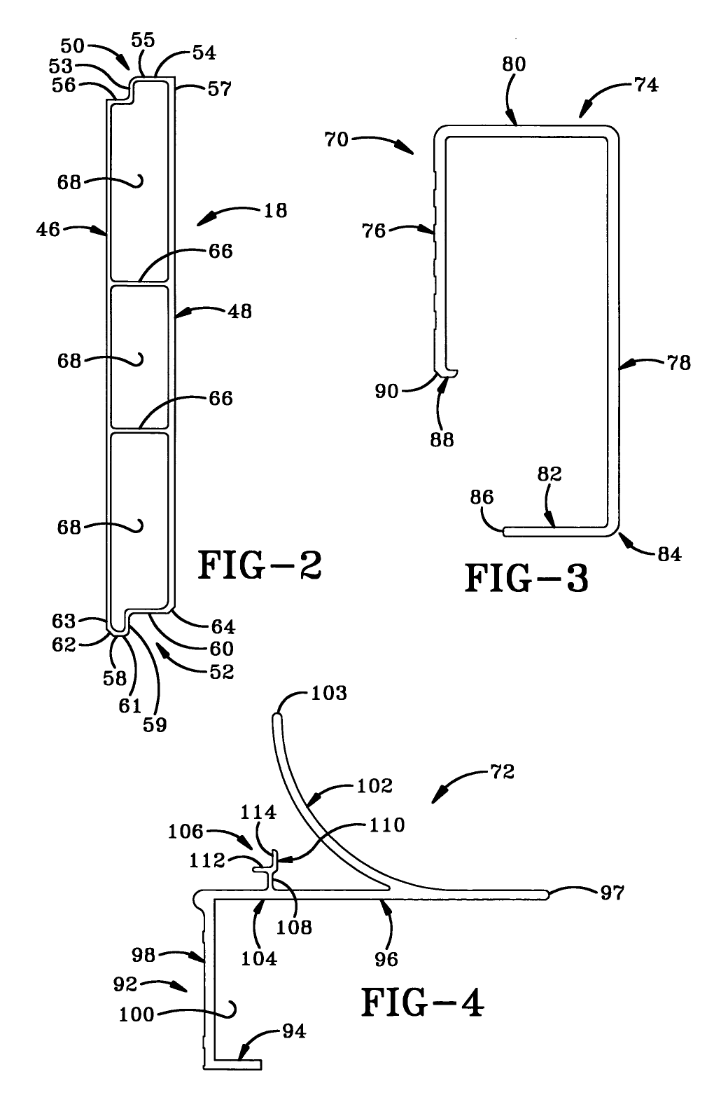

The panel of the present invention used in forming a trailer wall is indicated generally at 18 in FIGS. 1-2. Each hollow panel 18 takes the general form of a shiplap with overlapping edges. Panel 18 includes a pair of opposed walls or sides which are substantially flat and parallel to one another and elongated in the elongated direction of panel 18. These opposed walls constitute an outer wall 46 and an inner wall 48 which is thicker than outer wall 46, although walls 46 and 48 may have the same thickness or vary as desired. Preferably, inner wall 48 is disposed along the interior of the trailer to resist denting due to shifting cargo and the like and to provide additional material for a more durable wall. Panel 18 further includes a first connecting side 50 with an overlapping configuration and a second connecting side 52 with an overlapping configuration in opposed relation to first connecting side 50.

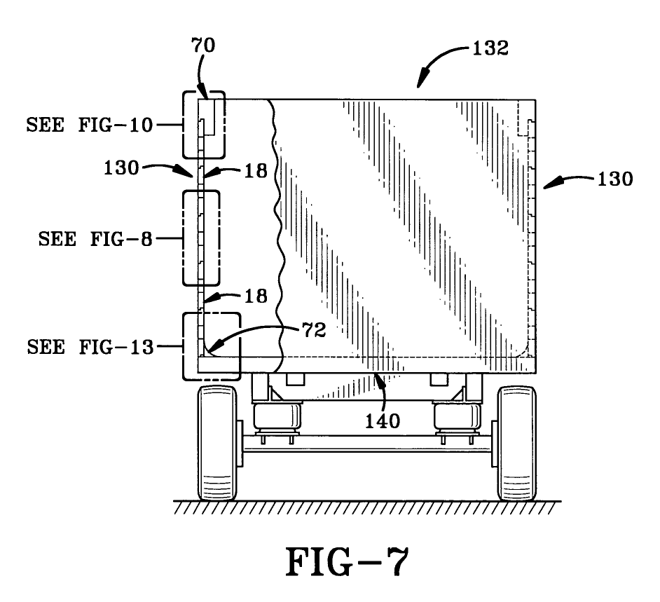

The first connecting side 50 of one panel 18 is configured to mate with the second connecting side 52 of another panel 18 in constructing the main structure of a trailer wall, such as trailer wall 130 (FIGS. 6-7). In the figures (such as FIG. 2) where panel 18 is shown in a vertical position as it would be when installed as part of a trailer wall, first connecting side 50 is shown in an upper position and second connecting side 52 is shown in a lower position although panel 18 may be inverted to reverse these relative locations. Preferably, panels 18 are situated to be elongated in a horizontal direction for reasons discussed in the background of this application, but may also be disposed so that they are elongated in a vertical or other direction. While panels 18 are shown in FIGS. 6-7 forming right and left sidewalls of trailer wall 130, the invention applies to formation of any of the sidewalls, thus further including front, rear, top and bottom sidewalls.

With reference to FIG. 2, first connecting side 50 includes a projection 54 connected to inner wall 48 and a shelf 56 connected to and extending from outer wall 46 to projection 54. More particularly, shelf 56 is connected to a step 53 of projection 54. Shelf 56 is substantially perpendicular to outer wall 46 and inner wall 48 and step 53 is substantially parallel to walls 46 and 48. Projection 54 further includes a terminal end 55 extending substantially perpendicularly from step 53 to inner wall 48. Projection 54 includes a portion 57 of inner wall 48. Thus, connecting side 50 is stepped between outer wall 46 and inner wall 48 and includes a hollow projection 54 bounded on three sides respectively by step 53, terminal end 55 and portion 57 of inner wall 48.

Second connecting side 52 includes a projection 58 connected to outer wall 46 and shelf 60 connected to and extending from inner wall 48 to projection 58. More particularly, shelf 60 is connected to a step 59 of projection 54. Shelf 60 is substantially perpendicular to outer wall 46 and inner wall 48 and step 59 is substantially parallel to walls 46 and 48. Projection 54 further includes a terminal end 61 extending substantially perpendicularly from step 59 to outer wall 46. Projection 54 includes a portion 63 of outer wall 46. Thus, connecting side 50 is stepped between outer wall 46 and inner wall 48 and includes a hollow projection 54 bounded on three sides respectively by step 59, terminal end 61 and portion 63 of outer wall 46.

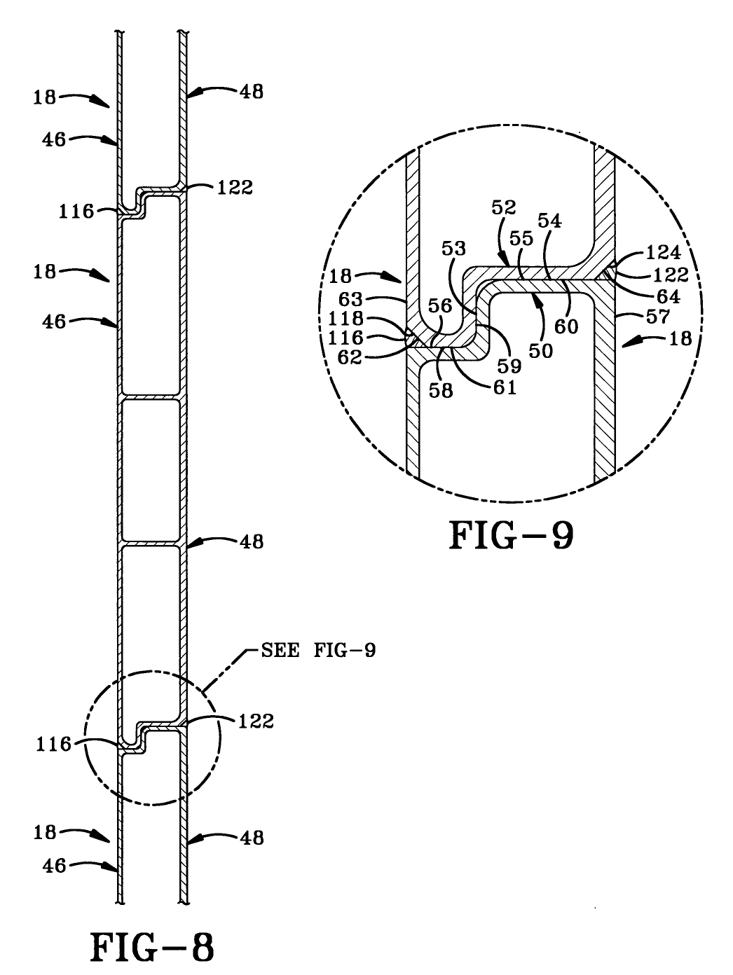

Projection 54 is wider than projection 58 and shelf 60 is wider than shelf 56, although this may vary. Thus, projection 54 and shelf 56 of one panel 18 is configured to mate respectively with shelf 60 and projection 58 of another panel. The difference of widths of projections 54 and 58 and of shelves 56 and 60 ensure that the respective inner walls 48 of each panel 18 are aligned along a common plane and that the respective outer walls 46 of each panel 18 are aligned along a common plane when panels are joined to form trailer wall 130. This is important when, as in the exemplary embodiment, outer wall 46 has a thickness different than that of inner wall 48. Outer wall 46 has a beveled edge 62 on projection 58 and inner wall 48 has a beveled edge 64 at the intersection of inner wall 48 and shelf 60. These beveled edges provide welding channels 118 and 124 (FIG. 9) between each adjacent pair of panels 18, as discussed further below. The intersection of terminal end 55 of projection 54 and inner wall 48 is at right angles and thus projection 54 is free of a beveled edge. Similarly, the intersection of shelf 56 and outer wall 46 is at right angles. Thus, outer and inner walls 46 and 48 terminate in square corners at first connecting side 50, which is therefore free of beveled edges which communicate with either outer wall 46 and inner wall 48.

Panel 18 also includes a pair of strengthening ribs 66 extending perpendicularly between walls 18 and 19 whereby panel 18 defines a plurality of open-ended interior passages 68, the central one of which is bound by outer wall 46, inner wall 48 and strengthening ribs 66 and the other two of which are each bound by outer wall 46, inner wall 48, one strengthening rib 66 and one of connecting sides 50 and 52. A plurality of panels 18 are connected to form the primary structure of trailer wall 130 (FIG. 6), which may also include a cap member 70 (FIG. 3) and a base member 72 (FIG. 4).

Cap member 70 is generally rectangular in cross-section except for a portion which is filled by a portion of a panel 18 when cap member 70 is attached to said panel 18, as detailed later herein. More particularly, cap member 70 includes an inverted U-shaped portion 74 having an outer wall 76 and an opposed inner wall 78, each extending downwardly from an intervening cap wall 80. Inner wall 78 is longer than outer wall 76. Cap member 70 includes a lower connecting wall 82 which extends perpendicularly from a lower end 84 of inner wall 78 and generally toward outer wall 76. Connecting wall 82 has a terminal end 86. Outer wall 76 has a terminal end 88 which is configured to mate with shelf 56 of first connecting side 50 of panel 18. Outer wall 76 has a beveled edge 90 adjacent terminal end 88.

Base member 72 (FIG. 4) includes a generally U-shaped portion 92 having a first leg 94 and a second leg 96 spaced from first leg 94, each leg extending from an intervening base 98 and defining an interior space 100 therebetween. Second leg 96 terminates in a terminal edge 97 distal base 98. Base member 72 further includes an arcuate stabilizing arm or support 102 cantilevered from second leg 96 outwardly in the general direction of base 98 and upwardly generally away from interior space 100. Arm 102 terminates in a tip 103. A connecting portion 104 of second leg 96 is disposed between base 98 and the intersection of second leg 96 and arm 102. A seat 106 extends from connecting portion 104 upwardly away from interior space 100 and includes a support 108 with an L-shaped rest 110 having a base 112 and a back 114 whereby rest 110 sits atop support 108. Back 114 is aligned with tip 103 of arcuate arm 102 substantially perpendicularly from second leg 96 of U-shaped portion 92.

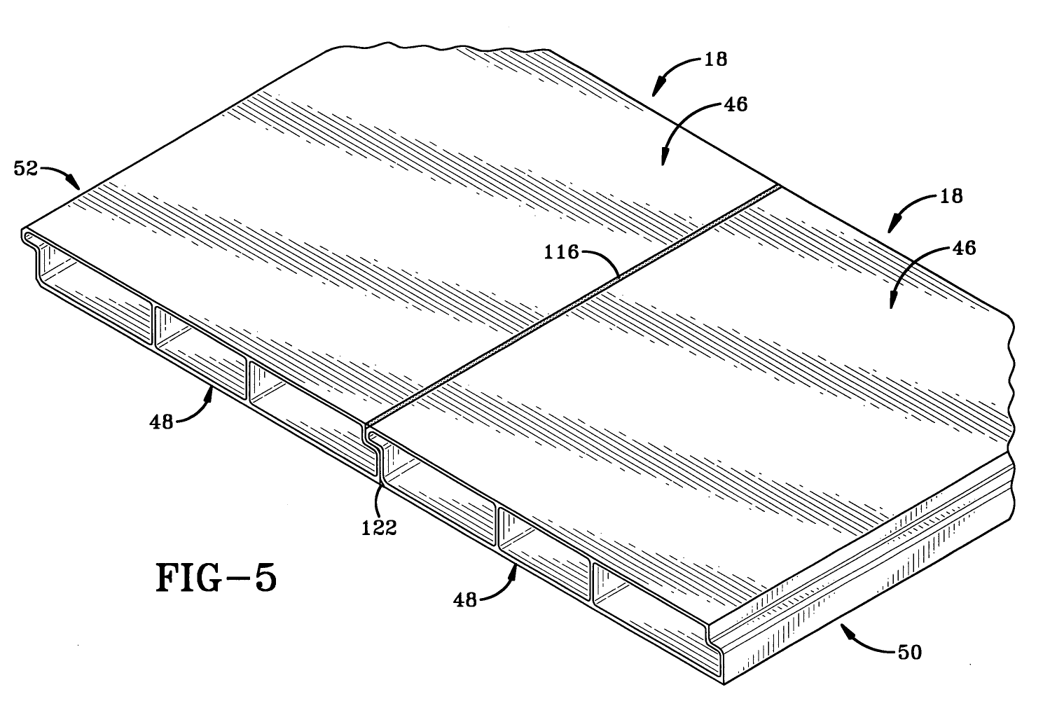

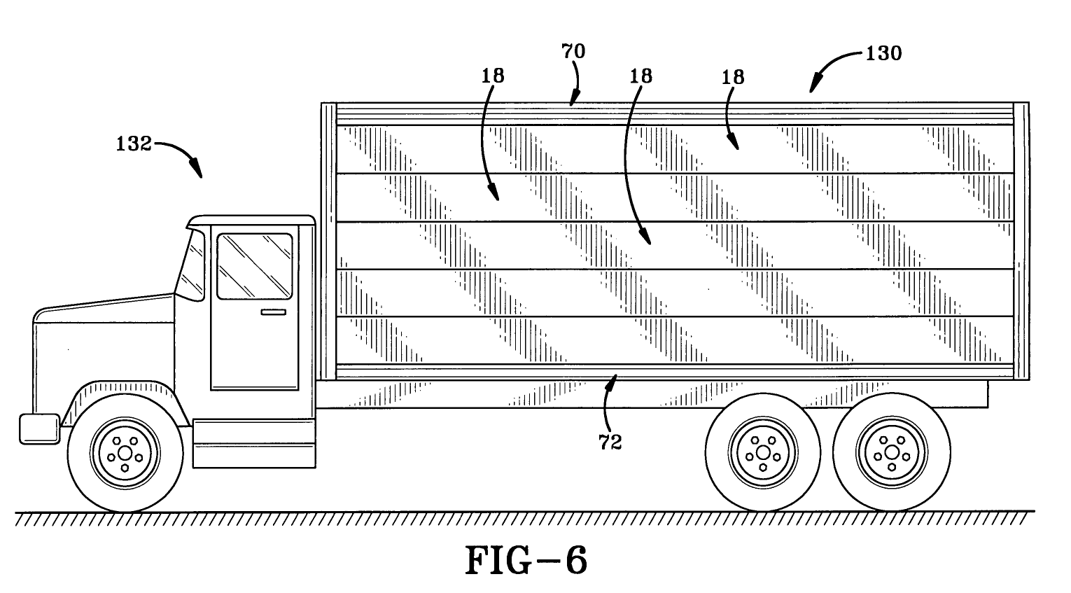

FIG. 5 shows a pair of panels 18 joined together by welds 116 and 122. Additional panels 18 are similarly welded together to form trailer wall 130 (FIGS. 6-7), which also includes one cap member 70 atop the panels 18 and one base member 72 upon which the panels are seated. Trailer wall 130 is typically used with a truck 132. FIGS. 8-9 show in greater detail panels 18 joined together by welds 116 and 122. Weld 116 is formed primarily in a channel 118 bounded by beveled edge 62 of on projection 58 along outer wall 46. Weld 122 is similarly formed along inner wall 48 within a channel 124 (FIG. 9) formed between beveled edge 64 of one panel 18 and shelf 60 of an adjacent panel 18.

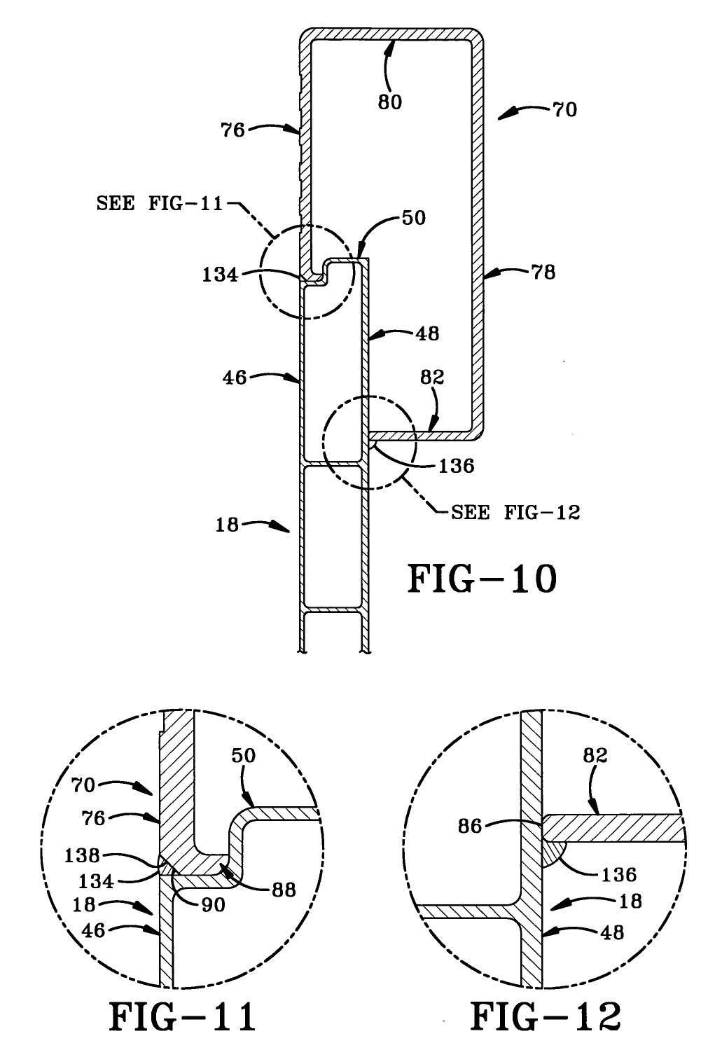

FIGS. 10-12 show cap member 70 welded to the uppermost panel 18 of trailer wall 130 at welds 134 and 136. More particularly, weld 134 joins terminal end 88 of outer wall 76 of cap member 70 to panel 18 at the intersection of outer wall 46 and shelf 56. Weld 134 is formed primarily in a channel 138 bounded by beveled edge 90 of cap member 70. Weld 136 joins terminal end 86 of lower connecting wall 82 of cap member 70 to inner wall 48 of said uppermost panel 18.

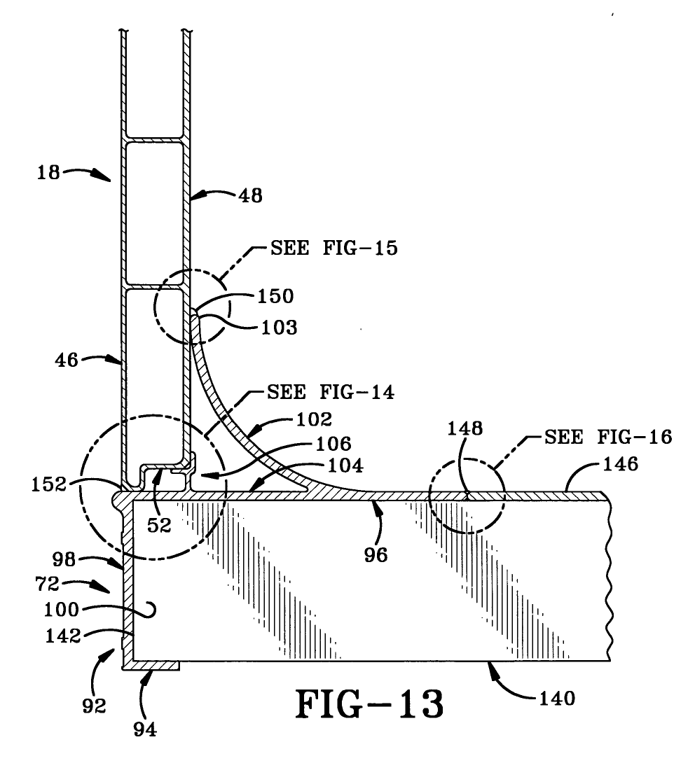

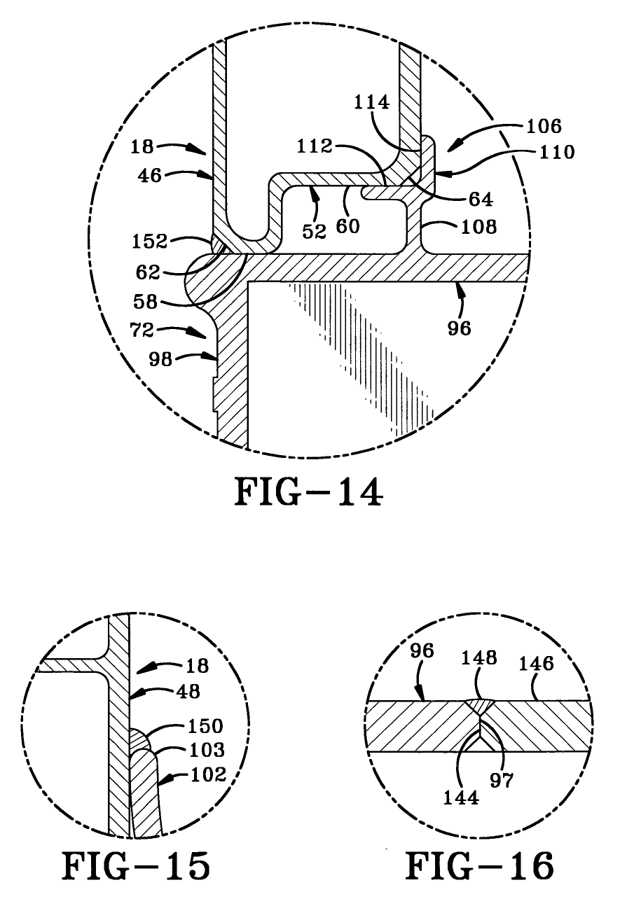

FIG. 13 shows base member 72 connected to the lowermost panel 18 of trailer wall 130 and to a floor frame 140 of truck 132. Base member 72 is fitted onto floor frame 132 so that a lateral edge 142 of floor frame 140 is received within interior space 100 of U-shaped portion 92. Terminal edge 97 of second leg 96 of base member 72 is joined to a lateral edge 144 of a floor bed 146 seated atop floor frame 140 at weld 148 (FIGS. 13 and 16), maintaining a substantially flush joint thereby. Said lowermost panel 18 is seated atop connecting portion 104 of second leg 96 of base member 72 and joined to base member 72 at welds 150 and 152. More particularly, tip 103 of arcuate arm 102 is joined to inner wall 48 of said lowermost panel 18 by weld 150 (FIGS. 13 and 15). Projection 58 of said lowermost panel 18 is seated on and joined to connecting portion 104 of second leg 96 at weld 152 (FIGS. 13-14) adjacent the intersection of portion 104 with base 98 of U-shaped portion 92. Shelf 60 of said lowermost panel 18 is seated on base 112 of L-shaped rest 110 of seat 106 and inner wall 48 of said lowermost panel 18 abuts back 114 of L-shaped rest 110 adjacent its intersection with shelf 60. Seat 106 provides an appropriate arrangement for seating of the shiplap configuration of panel 18. Arcuate arm 102 provides a smooth, strong support for attaching said lowermost panel 18. Thus, via the seating of lowermost panel 18 as described and via the connection of base member 72 to floor frame 140 and floor bed 146, trailer wall 130 is aligned in a substantially vertical position and firmly attached to the framework of truck 132.

Wall 130 is typically used with a truck like truck 132 (FIGS. 6-7), which most preferably has the capability of dumping contents out of the trailer. In the preferred embodiment, panels 18 and cap member 70 are elongated and when assembled, panels 18 are disposed atop one another in lengthwise fashion with cap member 70 sitting atop the upper panel 18, as seen in FIGS. 6-7. Trailer wall 130 may be used with trailers which fully enclose a load although the exemplary embodiment is a trailer with an open top.

Thus, trailer wall 130 provides a rigid joint between adjacent panels 18 and between a panel 18 and a cap member 70 to provide a sturdy wall having a flat exterior surface to minimize wind resistance during travel and a flat interior surface formed by respective inner walls 48 which are relatively thick to provide durability. In addition, in the preferred embodiment, panels 18 are elongated in a horizontal direction such that the joints between the panels are generally aligned with the direction of the material being dumped out of the rear of the trailer, to prevent undue wear from joints which are transverse to that flow, as discussed in the background of the present application. In addition, while trailer wall 130 may be formed of solid members having the same joints described herein, wall 130 is a generally hollow member which provides a relatively lightweight wall which is simultaneously strong and durable.

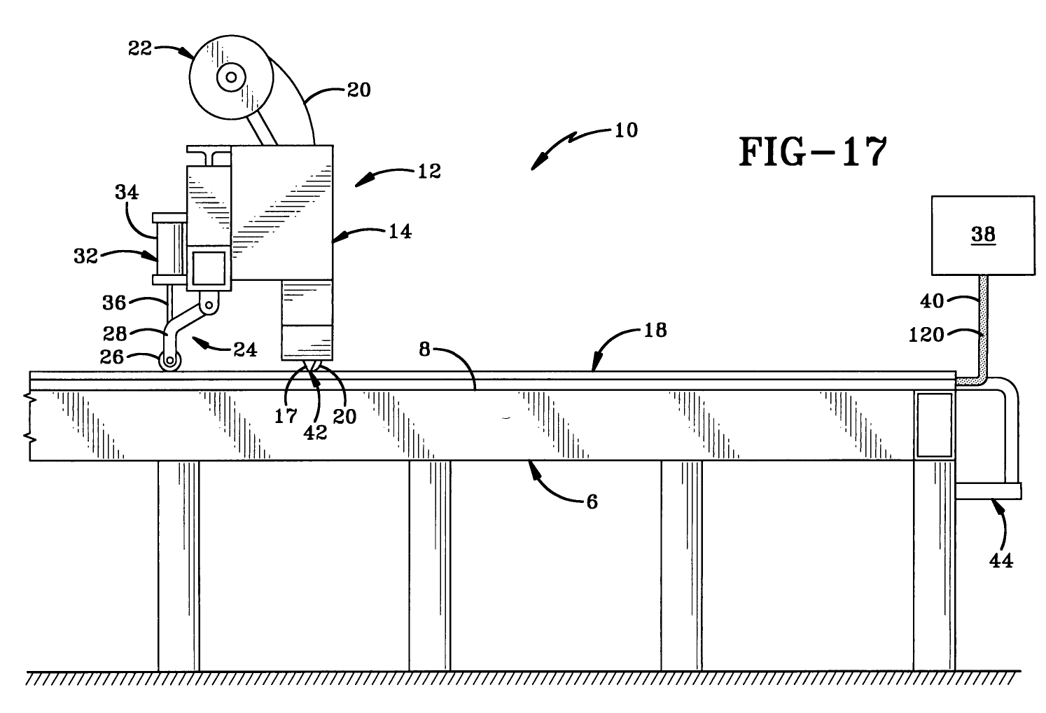

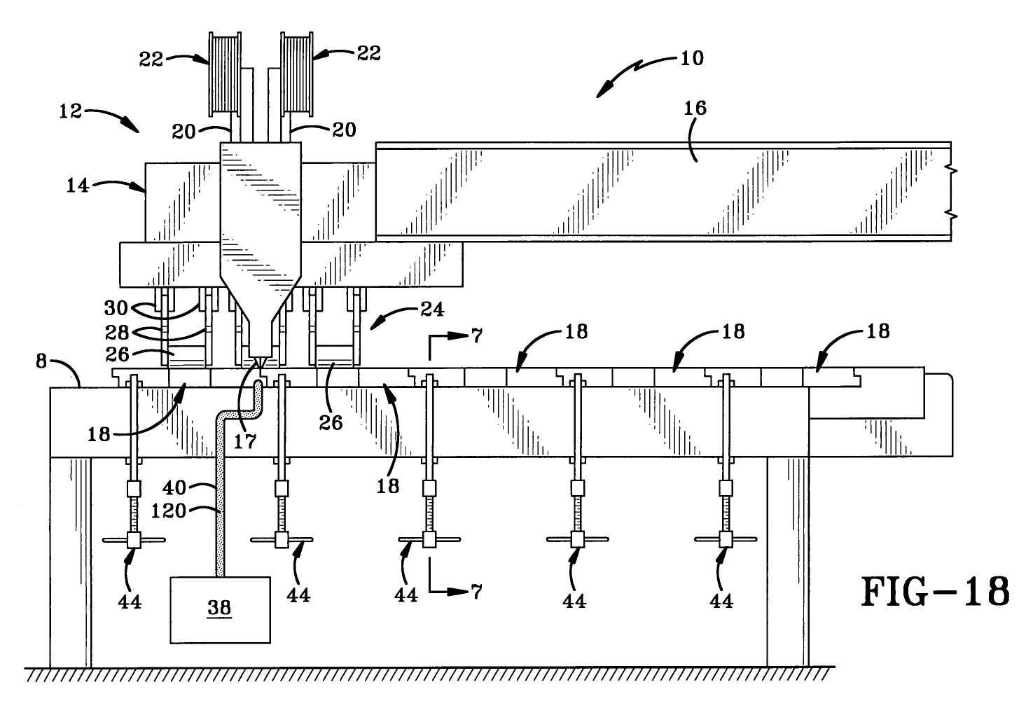

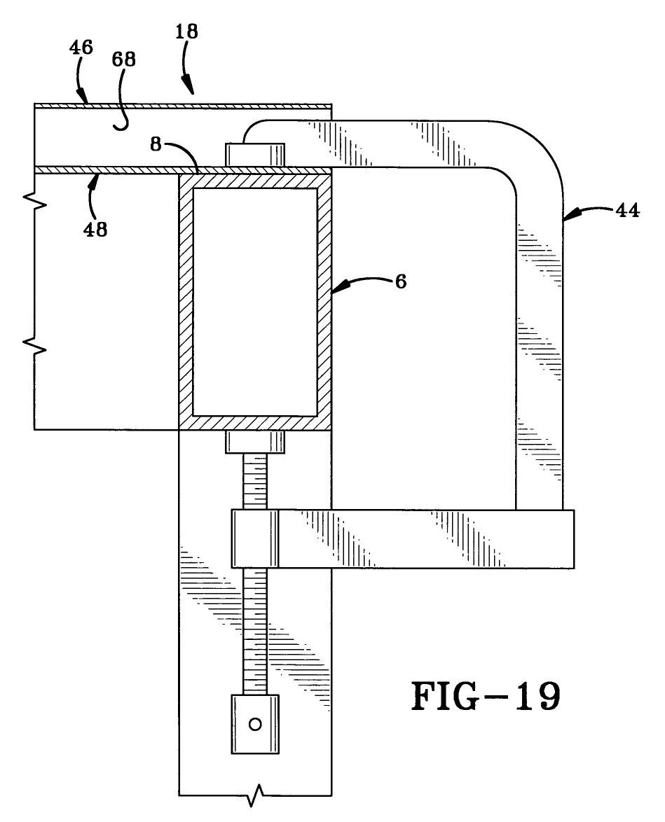

In accordance with the invention, the apparatus for manufacturing a trailer wall of the present invention is indicated generally at 10 in FIGS. 17-18. Apparatus 10 includes a welding unit 12 having a frame 14 which is mounted to a movable support arm 16 whereby welding unit 12 is movable. Typically, welding unit 12 is disposed above a work bench 6 having a work surface 8. Welding unit 12 also includes a welding tip 17 for welding elongated trailer wall members or panels 18 together using welding wire 20 which unrolls from reels 22.

One feature of the invention involves a pressure applicator 24 for pressing panels 18 toward work surface 8 of bench 6 extends from frame 14. Pressure applicator 24 includes a plurality of rollers 26 each rotatably mounted between a pair of spaced roller arms 28 which are pivotally mounted on frame 14 via mounting members 30. Pressure applicator 24 further includes a plurality of piston-cylinder combinations 32 (only one shown for simplicity) each having a cylinder 34 mounted on frame 14 and a piston 36 extending to a respective pair of roller arms 28.

According to another feature of the invention, apparatus 10 may also include a cooling unit 38 for passing a liquid or gas coolant 120 via conduit 40 through hollow panels 18 adjacent a point of welding 42 (FIGS. 17 and 21-23) adjacent welding tip 17. Cooling unit 38 may be a liquid or gas pump. Apparatus 10 may also include a plurality of clamps 44 to help hold panels 18 to work surface 8. Clamps 44 are located at both ends of panels 18, but are shown along only one end for simplicity.

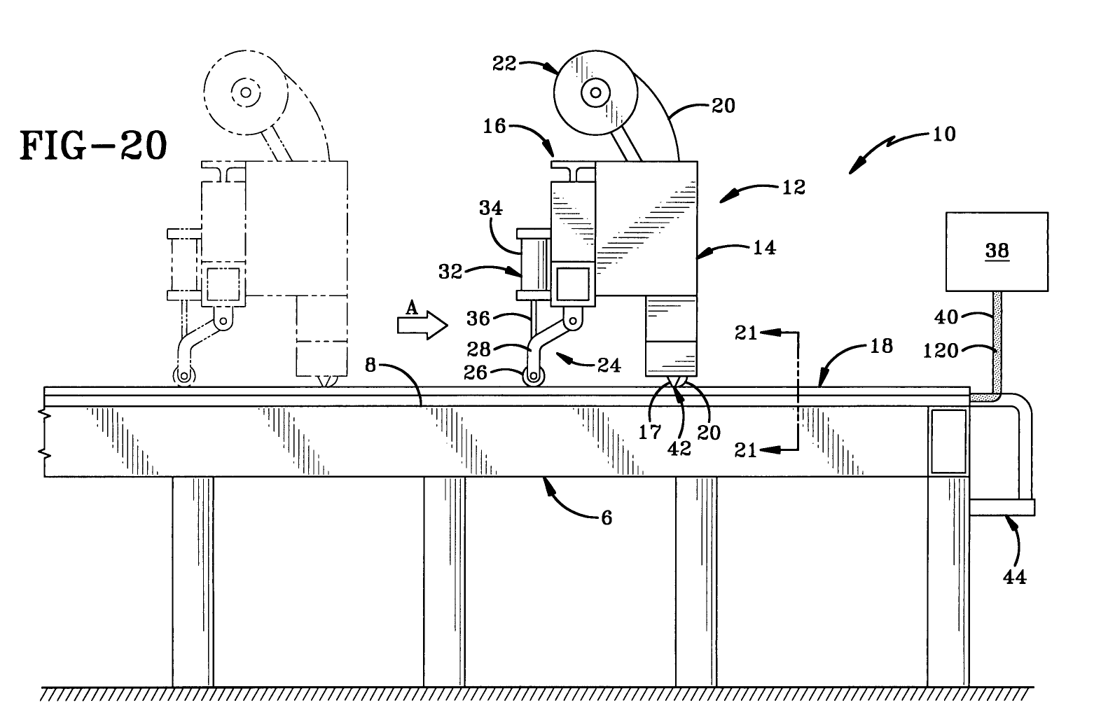

In accordance with the invention, the method of connecting a plurality of panels 18 in forming trailer wall 130 is described. Cap member 70 and base member 72 may also be included, as detailed further below. Referring to FIGS. 17-19, a plurality of panels 18 is positioned on work surface 8 of work bench 6, which is sufficiently firm to withstand the processes described hereafter. Each panel 18 adjacent ends thereof is clamped to work surface 8 with clamps 44 so that respective first connecting sides 50 abut or are closely adjacent second connecting sides 52 of one or more adjacent panels 18. Preferably, as shown in FIG. 19, inner wall 48 (as opposed to outer wall 46) faces work surface 8 during the initial phase of the process, as explained below. Clamp 44 is configured so that an upper jaw thereof is inserted within one of hollow chambers 68 to apply force directly to inner wall 48 in clamping inner wall 48 to work surface 8. This avoids deformation of outer wall 46 which may occur if outer wall 46 were clamped instead.

With reference to FIG. 20 and in accordance with a feature of the invention, welding unit 12 moves in the direction of arrow A to weld a pair of adjacent panels 18 to one another along respective outer walls 46 while pressing panels 18 down on work surface 8 of work bench 6. More particularly, support arm 16 moves in the direction of arrow A and piston-cylinder combination 32 is operated to press rollers 26 against outer wall 46 of the adjacent panels 18 being welded together. Thus, piston-cylinder combination 32 forces panels 18 toward work surface 8 of bench 6 via rollers 26. Rollers 26 thus apply pressure to panels 18 in a continuous manner.

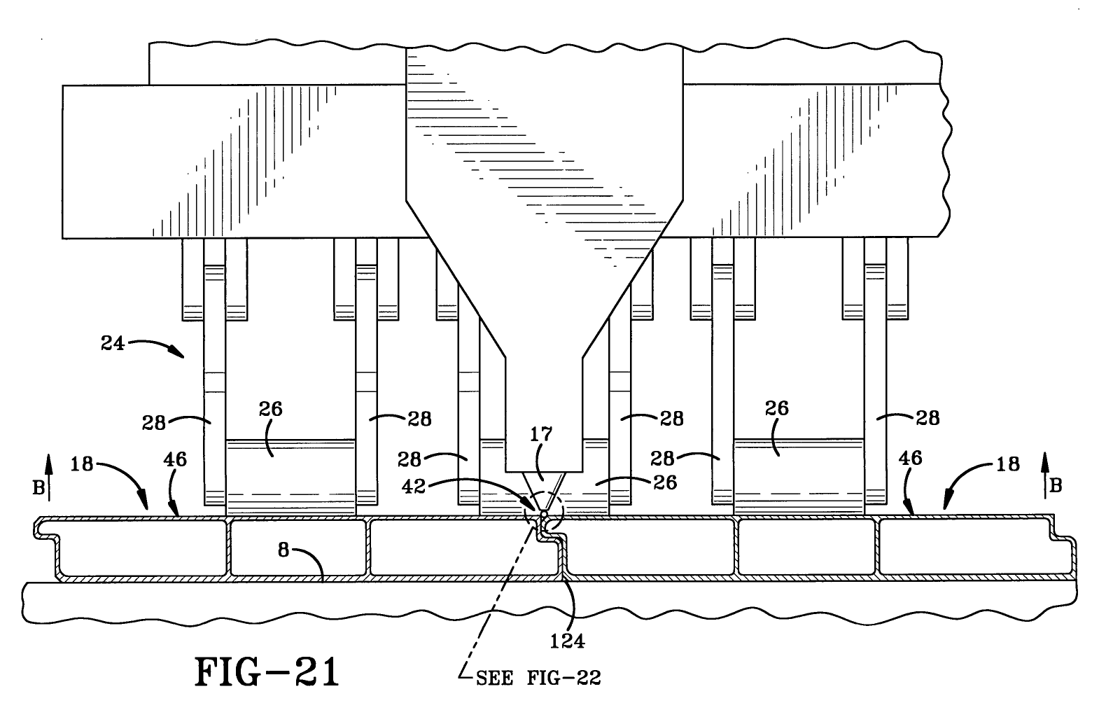

Typically, piston-cylinder combination 32 is a hydraulically or pneumatically powered piston and cylinder, although any suitable source of pressure may take the place of piston-cylinder combination 32 which is able to force rollers 26 toward panels 18. Because elongated panels 18 are typically fairly lengthy, the pressure applied by rollers 26 is important in keeping panels 18 substantially flat between the clamping positions of clamps 44 at either end of panels 18. FIG. 21 shows the use of three rollers 26 although one or more rollers 26 may be used. The center roller 26 is in contact with each of the adjacent panels 18 being welded together, and this is the most preferred positioning, particularly if only one roller 26 is used.

Using a plurality of rollers 26 and/or at least one roller 26 which is elongated to provide a relatively large surface area of contact between roller or rollers 26 and panels 18 is particularly helpful in preventing damage to the relatively thin walls 46 and 48 of panels 18. In addition, the shiplap configuration of panels 18, or a similar configuration wherein a portion of one of the panels overlays a portion of another panel during assembly, the overlaying portion of the one panel thus presses on the underlying portion of the other panel, thereby assisting in the process of pressing the panels toward work surface 8 and creating closer engagement between each pair of panels being joined. In addition to pressing panels 18 downwardly, the outer rollers 26 may be cambered somewhat to assist in forcing the two adjacent panels toward one another to facilitate a close fit between the respective connecting sides 50 and 52 being joined.

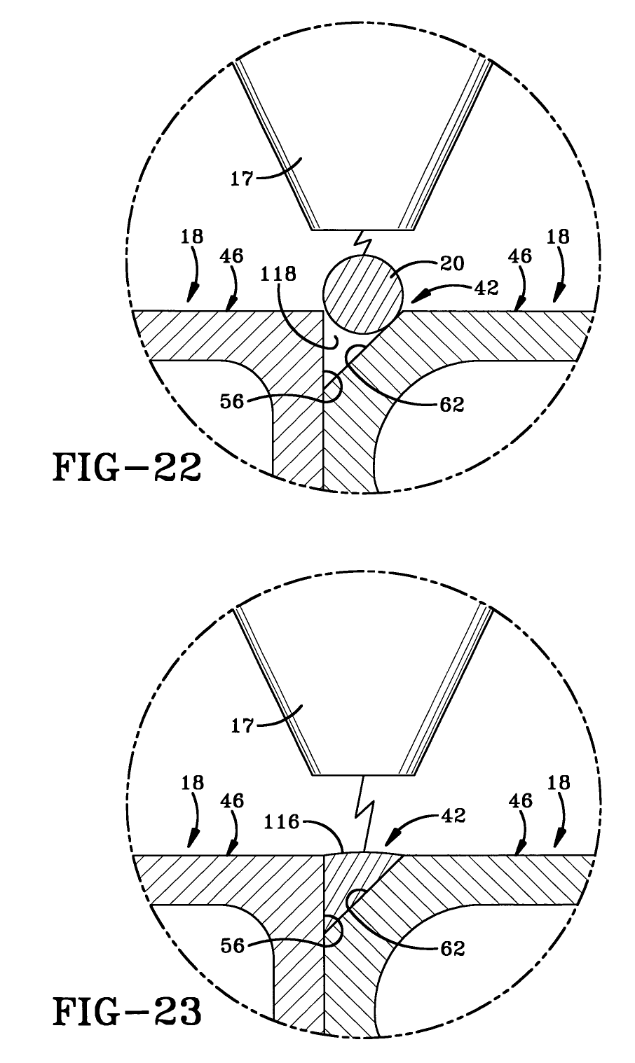

As welding unit 12 moves along panels 18 with rollers 26 pressing respective panels 18 to work bench 8 (FIGS. 20-21), welding wire 20 is unreeled from reels 22 and positioned along channel 118 (FIG. 22), and welding tip 17 is powered to form continuous weld 116 in channel 118 to weld panels 18 together along respective outer walls 46 (FIG. 23). While a continuous weld is preferred for strength and to provide a sealing engagement between each pair of panels 18, a continuous weld is not required depending on the type of wall being formed. The seal formed by a continuous weld is preferred for use with trailers used for carrying slurries or other loads having liquid that may leak through the trailer wall. Of course, such a sealed wall is preferred to keep rain water out of the trailer for certain types of trailers. If a continuous weld is not applied it is nonetheless still preferred that panels 18 be welded together at a plurality of locations substantially along the entire length of panels 18.

Another feature of the invention is the cooling of panels 18 adjacent point of welding 42 which is adjacent welding tip 17 at any given time that a weld is being formed. Thus, there are a plurality of points of welding 42 between the panels 18 being joined together. In particular, cooling unit 38 (FIGS. 18 and 20) pumps or otherwise causes coolant 120 in the form of cooled liquid or gas, preferably air, to move through conduit 40 and through at least one passage 68 of panels 18, especially the passages 68 which are bounded in part by the connecting sides 50 and 52 being welded together. The cooling effect provided by the movement of coolant 120 substantially reduces the bowing of panels 18 which normally occurs in relation to the heat caused by the welding process. More particularly, there is a tendency for the joined panels 18 to bow downwardly when laying horizontally whereby the connecting sides 50 and 52 distal weld 116 are, as shown by arrows B in FIG. 21, lifted upwardly with respect to weld 116. With specific regard to use of joined panels 18 as a trailer wall like wall 130, it is preferred that outer walls 46 are welded together first so that any bowing that does occur is directed inwardly toward the interior of the trailer, thus creating a wall which is generally concave on the outside and generally convex on the inside. Thus, when used with heavy loads, especially of loose materials or slurries, the inwardly bowed wall compensates for the outward force created by the load within the trailer.

Once weld 116 is formed to join respective outer walls 46, joined panels 18 are turned over and the same process is followed to join adjacent inner walls of respective panels 18 to form continuous weld 122 (FIGS. 8-9), this time within channel 124 (FIGS. 9 and 21). During the welding of inner walls 48, rollers 26 serve the same purpose as during welding of outer walls 46 although rollers 26 also counter any bowing created by the initial welding along outer walls 46. The nature of the bowing created during the initial welding also serves to prestress the joined panels 18 in one direction and the subsequent welding of panels 18 once turned over tends to apply force in the opposite direction, that is, a force which tends to bow the wall in the opposite direction. As a result, tension is induced in the wall which creates a relatively strong and less flexible wall structure. FIG. 12 shows two panels 18 welded together so that the wall formed thereby is substantially flat, although as noted above it may bow to some degree. The pressure from rollers 26 is one significant factor in making the wall substantially flat and the cooling via cooling unit 38 is another such significant factor.

If desired, a work bench may be altered to accommodate panels 18 having different configurations while still utilizing the essence of the above process to manufacture a wall. For instance panels 18 may not be substantially flat and a work bench suitable to this variation may be used to provide adequate support. In addition, for example, a work surface may be adapted to accommodate cap member 70 and a panel 18 (or a plurality of joined panels 18) so that the process may be used to join cap member 70 to a panel 18, at least with respect to joining outer wall 76 of cap member 70 to outer wall 46 of panel 18.

It will be appreciated that a number of changes may be made to the exemplary embodiments which are within the scope of the invention. For instance, the welding unit may take a variety of forms and need not apply a continuous weld, as previously noted. In addition, the welding unit may be movable by other configurations than that shown. Further, the panels may be moved instead of or in addition to the welding unit and thus, relative movement between the panels and welding unit is contemplated for application of the multiple welds or a continuous weld. While a work bench having a substantially horizontal work surface is typical and generally preferable in most cases, the concept of the invention can easily be adapted to work surfaces of any desired inclination.

In addition, the rollers may be axially wider or narrower, although as suggested above, rollers which are too narrow more readily tend to deform the wall of the panel on which they press. In addition, the rollers may be movably mounted other than pivotally. For example, they may be slidably mounted so that a piston-cylinder or other source can move them to provide pressure on the panels. The rollers may even be used separately from the welding unit although it is important that the rollers apply pressure sufficiently close to the points of welding in order to keep the panels pressed against or closely adjacent to the work surface adjacent the points of welding.

Further, while the use of rollers is most preferred, it is contemplated that an alternate pressure applicator may be used. For instance, a pressure applicator which slides over the surface of the panels with a relatively small amount of friction between the applicator and panels may be used.

While the use of shiplap panels with the present method offers an advantage, as discussed earlier, the method of the invention is applicable for other panels or wall members. Shiplap panels also provide desirable lateral strength to the wall (with respect to a vertical wall) due to the overlapping edges.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method of manufacturing a trailer sidewall comprising the steps of:
welding a first substantially hollow wall member to a second substantially hollow wall member at a plurality of points of welding by creating relative movement between a welding tip and the wall members; and
pressing the wall members in a continuous manner with a pressure applicator toward a work surface whereby the pressing occurs adjacent each respective point of welding during formation of each respective point of welding.

2. The method of claim 1 wherein the step of pressing includes the step of rolling at least one rotatable roller along at least the first wall member.

3. The method of claim 2 wherein a portion of the first wall member overlays a portion of the second wall member adjacent the points of welding; and wherein the step of pressing includes the step of pressing the portion of the second wall member with the portion of the first wall member.

4. The method of claim 2 wherein the step of pressing includes the step of operating a piston-cylinder combination to move the at least one roller against at least the first wall member.

5. The method of claim 2 wherein each wall member includes first and second spaced walls connected to one another by a pair of opposed connecting sides;
wherein the method further includes the steps of positioning the second spaced walls of the respective wall members toward the work surface and positioning one connecting side of the first wall member adjacent one connecting side of the second wall member prior to the steps of pressing and welding;
wherein the step of welding includes welding the wall members together along the respective first spaced walls of the wall members; and
wherein the method further includes the subsequent steps of:
positioning the first spaced walls toward the work surface; and
welding the wall members together along the respective second spaced walls of the wall members while pressing at least one of the wall members with the at least one rotatable roller toward the work surface.

6. The method of claim 2 further including the step of moving the welding tip and the at least one roller in unison during the steps of welding and pressing.

7. The method of claim 1 wherein each wall member has first and second opposed ends; wherein each wall member has a length defined from the first end to the second end and is elongated from the first end to the second end; wherein each wall member has first and second spaced walls defining therebetween an interior chamber;
wherein the method further includes the steps of positioning the wall members with the respective first walls toward the work surface and the respective second walls spaced from the work surface; inserting a portion of a clamp into the interior chamber of the at least one wall member; and clamping the first wall of the at least one wall member adjacent each of the ends thereof to the work surface with the clamp; and
wherein the step of welding includes the step of forming the points of welding between the wall members along substantially the entire length of the wall members.

8. The method of claim 1 further including the step of cooling the wall members adjacent the points of welding during the step of welding.

9. The method of claim 8 wherein each wall member defines an open-ended passage; and wherein the step of cooling includes moving a coolant through at least one of the passages.

10. The method of claim 9 wherein the coolant is a gas.

11. A trailer sidewall comprising:
a plurality of substantially hollow wall members formed of metal; each wall member having first and second spaced walls and first and second opposed connecting sides each extending between and connected to the first and second walls;
each connecting side including a hollow projection formed in part by one of the first and second walls;
each first connecting side having a first beveled edge communicating with the respective first wall and a second beveled edge communicating with the respective second wall;
each second connecting side being free of a beveled edge communicating with the respective first wall and free of a beveled edge communicating with the respective second wall; and
each adjacent pair of wall members being joined together with the projection of the first connecting side of one of the adjacent pair overlapping the projection of the second connecting side of the other of the adjacent pair.

12. The sidewall of claim 11 wherein each connecting side is stepped between the first wall and the second wall.

13. The sidewall of claim 11 wherein each projection is hollow.

14. The sidewall of claim 11 wherein the projection of the first connecting side of each wall member is formed in part by one of the first and second walls thereof; and wherein the projection of the second connecting side of each wall member is formed in part by the other of the first and second walls thereof.

15. The sidewall of claim 11 wherein each of the first and second walls are flat and substantially parallel to one another.

16. The sidewall of claim 11 wherein each first connecting side of the one of the adjacent pair of wall members forms a mating connection with the second connecting side of the other of the adjacent pair.

17. The sidewall of claim 16 wherein the projection of each first connecting side is connected to a shelf which is connected to one of the first and second walls; and wherein the projection of each second connecting side is connected to a shelf which is connected to the other of the first and second walls; and wherein the projection of each first connecting side of one of each of the adjacent pair of wall members abuts the shelf of the second connecting side of the other of the respective adjacent wall member.

18. The sidewall of claim 11 wherein the projection of each first connecting side is wider than the projection of each second connecting side and the shelf of the second connecting side is wider than the shelf of the first connecting side; wherein each first wall is an inner wall forming a portion of an interior of the trailer sidewall and each second wall is an outer wall forming a portion of an exterior of the trailer sidewall; ane wherein the inner wall is thicker than the outer wall.

19. The sidewall of claim 11 wherein each adjacent pair of wall members is welded to one another along the first and second beveled edges of one of the wall members of said adjacent pair.

20. The sidewall of claim 11 wherein each wall member includes at least one strengthening rib extending between the first and second walls thereof whereby the wall member defines a plurality of open-ended interior passages.
